(19) United States
(12) Patent Application Publication
(10) Pub. No.: US 2026/0350825 A1
(43) Pub. Date: Nov. 5, 2026

(54) APPARATUS AND SYSTEM FOR DETERMINING SHAPE OF OBJECT IN IMAGE

(71) Applicant: The Hong Kong University of Science and Technology, Hong Kong (CN)

(72) Inventors: Xiaomeng LI, Hong Kong (CN); Jiewen YANG, Hong Kong (CN); Xinpeng DING, Hong Kong (CN)

(21) Appl. No.: 19/488,929

(22) PCT Filed: Aug. 6, 2024
(86) PCT No.: PCT/CN2024/110006

§ 371 Date: Dec. 1, 2025

Related U.S. Application Data
(60) Provisional application No. 63/580,717, filed on Sep. 6, 2023.

(51) Int. Cl. G06T 7/50; G06T 7/12

(52) U.S. Cl. CPC G06T 7/50; G06T 7/12; G06T 2207/10016; G06T 2207/20072; G06T 2207/20081; G06T 2207/20084; G06T 2207/30048

(57) ABSTRACT

A method for determining a shape of an object in an image, comprising: generating, for each of a first plurality of images, a first plurality of nodes based on a first plurality of features extracted from each of the first plurality of images, the first plurality of features associated with a shape of an object in the first plurality of images; determining, for each of the first plurality of nodes, one or more other nodes based on historical data indicating a previous position and a time associated with the previous position of each of the first plurality of nodes; and determining the shape of the object for each of the first plurality of images based on the one or more other nodes.

### CROSS-REFERENCE TO RELATED APPLICATIONS

This application claims priority to, and the benefit of, U.S. Provisional Patent Application No. 63/580,717 filed on Sep. 6, 2023, the disclosure of which is hereby incorporated by reference in its entirety.

### FIELD

The present disclosure relates generally to an apparatus and system for determining a shape of an object in an image.

### BACKGROUND

Echocardiography is a non-invasive diagnostic tool that enables the observation of all the structures of the heart. It can capture dynamic information on cardiac motion and function making it a safe and cost-effective option for cardiac morphological and functional analysis. Accurate segmentation of cardiac structure, such as left ventricle (LV), right ventricle (RV), left atrium (LA), and right atrium (RA), is crucial for determining essential cardiac functional parameters, such as ejection fraction and myocardial strain. These parameters can assist physicians in identifying heart diseases, planning treatments, and monitoring progress. Therefore, the development of an automated structure segmentation method for echocardiogram videos is of great significance.

However, existing methods to segment such echocardiogram videos and images are unable to generate satisfactory performance, as they fail to model local information (e.g., relating to a shape of a heart comprising a LV, RV, LA, and RA) and also do not consider the cyclic properties of a cardiac cycle of the heart.

New methods, apparatus, systems that assist in advancing technological needs and industrial applications in this area are desirable.

### SUMMARY

A method comprises generating, for each of a first plurality of images, a first plurality of nodes based on a first plurality of features extracted from each of the first plurality of images, the first plurality of features associated with a shape of an object in the first plurality of images; determining, for each of the first plurality of nodes, one or more other nodes based on historical data indicating a previous position and a time associated with the previous position of each of the first plurality of nodes; and determining the shape of the object for each of the first plurality of images based on the one or more other nodes.

Other embodiments will be described herein.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the disclosure will be better understood and readily apparent to one of ordinary skill in the art from the following written description, by way of example only, and in conjunction with the drawings, in which:

FIG. 1 shows an exemplary illustration of a method for determining a shape of an object in an image according to certain embodiments of the present disclosure.

FIG. 2 shows an exemplary illustration of a temporal-wise cycle consistency (TCC) module and a spatial-wise cross-domain graph matching (SCGM) module according to certain embodiments of the present disclosure.

FIG. 3 shows an exemplary illustration of a workflow of a Recursive Graph Convolutional Cell (RGCC) according to certain embodiments of the present disclosure.

FIG. 4 shows exemplary results on datasets from left ventricle (LV) segmentation according to certain embodiments of the present disclosure.

FIG. 5 shows exemplary results for how SCGM and TCC affects an averaged Dice score according to certain embodiments of the present disclosure.

FIG. 6 shows exemplary results for how a classification loss and a graph matching loss of the SCGM affects an averaged Dice score according to certain embodiments of the present disclosure.

FIG. 7 shows exemplary results for how a temporal consistency loss and a global domain-adversarial loss of the TCC affects an averaged Dice score according to certain embodiments of the present disclosure.

FIG. 8 shows exemplary segmentation results from three echocardiogram images according to an embodiment of the present disclosure.

FIG. 9 shows an exemplary analysis of how different attentions (e.g., cross-domain attention and internal domain attention) can affect performance of segmentation results according to an embodiment of the present disclosure.

FIG. 10 shows an exemplary illustration of Dice scores of segmentation results for each frame in an echocardiogram video according to an embodiment of the present disclosure.

FIG. 11 shows a schematic diagram of an exemplary computing device suitable for use in determining a shape of an object in an image.

### DETAILED DESCRIPTION

Embodiments of the present disclosure will be described, by way of example only, with reference to the drawings. Like reference numbers and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “detecting”, “estimating”, “comparing”, “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

### EXEMPLARY EMBODIMENTS

Various embodiments of the present disclosure relate to a method and system for determining a shape of an object in an image.

### DEFINITION OF TERMS

In the present disclosure, an image refers to a visual representation as commonly known in the art. The image may be a photograph, a video frame, for example a frame from a video (e.g., a video comprising a plurality of video frames), or other similar media. An image may be from a source domain (e.g., a dataset with labels and ground truth information) or from a target domain (e.g., a dataset from which a shape of an object is to be determined), and may be used as input in a segmentation network for determining a shape of an object in an image. Although echocardiogram (e.g., an ultrasound test that checks the structure and function of a heart) images and videos are referred to herein, it will be appreciated that usage of other similar types of images and videos are also possible.

An object refers to an entity captured in the image. In the present disclosure, a shape of the object is to be determined (e.g., a determination of a visual form of the object). The object may comprise one or more parts or structures within it that may require segmentation in order to determine a shape of each segment. For example, the object may be a heart shown in an echocardiogram image, and the object may be segmented into segments such as left ventricle (LV), right ventricle (RV), left atrium (LA), and right atrium (RA) of the heart. A shape for the heart and for each segment of the heart (e.g., LV, RV, LA and RA) may then be determined. In an example, the object may also be one or more of the LV, RV, LA and RA of a heart. Although a heart is referred to as the object in the present disclosure, it will be appreciated that the object may refer to other entities depending on the images and videos used.

A feature refers to an attribute or variable associated with the object that may be extracted (e.g., by a feature extractor of a segmentation network) from the image for use in determining a shape of the object. For example, in a temporal-wise cycle consistency (TCC) process, the extracted feature may be used to generate a plurality of nodes in which each node represents a pixel associated with the feature. For each node, one or more other nodes may be determined based on a K nearest neighbour on a hidden state of each node. A hidden state refers to historical data indicating a previous position of each node and a time associated with the previous position. The shape of the object may then be determined based on the one or more other nodes, advantageously taking into account cyclical consistency of a heart and thus improving accuracy of the determination. Further, a plurality of edges for connecting the one or more other nodes with each of the plurality of nodes may be determined, and a global representation may be generated for the image. The global representation refers to a representation of the image (or a plurality of images, either in the source domain or the target domain) which is connected to all other nodes and edges (e.g., all other nodes and edges generated from other videos or pluralities of images that are also used as input in the segmentation network) to facilitate passing of information and messages throughout the network. For example, a first global representation may be generated based on an image or a plurality of images from the target domain and a second global representation may be generated based on an image or a plurality of images from the source domain, and these global representations may be used for determining a total temporal consistency loss which may advantageously be used for improving accuracy of determining the shape of the object.

In another example, in a spatial-wise cross-domain graph matching (SCGM) process, an extracted feature and its corresponding pseudo label (e.g., a label that is predicted by the network for unlabeled training data) may be used to generate a graph for modelling a corresponding image. A first graph may be generated for an image (or a first plurality of images) of the target domain and a second graph may be generated for an image (or a second plurality of images) of the source domain. An alignment between the first (target domain) graph and the second (source domain) graph may be performed based on an adjacency matrix (e.g., a N×M matrix in which N and M refers to a total number of nodes in source domain and target domain respectively, in which each element of the matrix represent an existence of an edge that connect a pair of nodes between graphs) to reduce a difference (domain gap) between both domains, thereby improving accuracy of the determination of the shape of the object. A classification loss may be determined based on the aligned first and second graphs. Further, a transport cost matrix (e.g., a distance matrix that is calculated for each feature between the source domain and the target domain) may also be determined based on the aligned first and second graphs (e.g., utilizing a Sinkhorn algorithm (an iterative method also known as the Sinkhorn-Knopp algorithm, used to solve optimal transport problems and compute a Sinkhorn distance between two probability distributions) or other similar algorithm), and a graph matching loss may be determined based on the transport cost matrix. The classification loss and graph matching loss may be used to optimise the network and eliminate influence of domain shift (e.g., from source domain to target domain).

### DETAILED DESCRIPTION

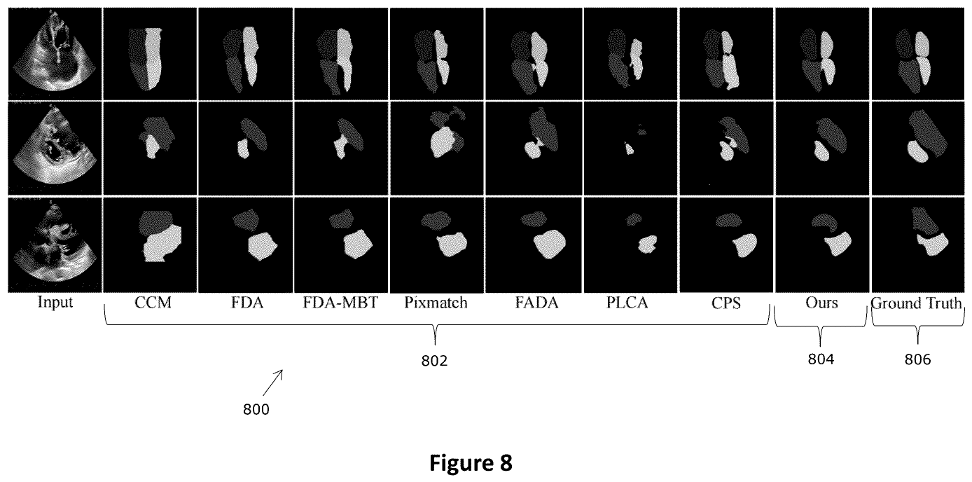

Unsupervised domain adaptation (UDA) segmentation for echocardiogram videos has not been explored yet, and the most intuitive way is to adapt existing UDA methods designed for natural image segmentation and medical image segmentation. In general, existing methods can be grouped into 1) the image-level alignment methods that focus on aligning the style difference to minimize the domain gaps, such as Probabilistic Latent Component Analysis (PLCA), Pix-Match and Fourier-based UDA; and 2) feature-level alignment methods that use global class-wise alignment to reduce the discrepancy between source and target domains. However, applying these methods directly to cardiac structure segmentation in echocardiogram videos generated unsatisfactory performance; see for example the results 802 in comparison with ground truth data 806 as shown in illustration 800 of FIG. 8. We thus consider two possible reasons: (1) Existing UDA methods primarily focused on aligning the global representations between the source and target domain while neglecting local information, such as LV, RV, LA, and RA. The failure to model local information during adaptation leads to restricted cardiac structure segmentation results; and (2) Most existing methods were mainly designed for 2D or 3D images, which does not consider the video sequences and the cyclic properties of the cardiac cycle. Given that heartbeat is a periodically recurring process, it is essential to ensure that the extracted features exhibit cyclical consistency.

To address the above limitations, the present disclosure refers to a novel graph-driven UDA method for echocardiogram video segmentation. The proposed method consists of two novel designs: (1) Spatial-wise Cross-domain Graph Matching (SCGM) module and (2) Temporal Cycle Consistency (TCC) module. SCGM is motivated by the fact that the structure/positions of the different cardiac structures are similar across different patients and domains. For example, the left ventricle's appearance is typically visually alike across different patients. The SCGM approach reframes domain alignment as a fine-grained graph-matching process that aligns both class-specific representations (local information) and the relationships between different classes (global information). By doing so, it is possible to simultaneously improve intra-class coherence and inter-class distinctiveness.

The proposed TCC module is inspired by the observation the recorded echocardiogram videos exhibit cyclical consistency. Specifically, the TCC module utilizes a series of recursive graph convolutional cells to model the temporal relationships between graphs across frames, generating a global temporal graph representation for each patient. A contrastive objective is utilized that brings together representations from a same video while pushing away those from different videos, thereby enhancing temporal discrimination. By integrating SCGM and TCC, the proposed method can leverage prior knowledge in echocardiogram videos to enhance inter-class differences and intra-class similarities across source and target domains while preserving temporal cyclical consistency, leading to a better UDA segmentation result, for example as shown in results 804 of the proposed method in comparison with ground truth 806 in illustration 800 of FIG. 8.

Existing UDA segmentation methods are typically utilized for segmenting natural and medical images. For natural image segmentation, adversarial-based domain adaptation methods and multi-stage self-training methods, including single stage and multi-stage are the most commonly used training methods. The adversarial method aims to align the distributions and reduce the discrepancy of source and target domains through the Generative Adversarial Networks (GAN) framework. At the same time, the self-training generate and update pseudo labels online during training, such as applying data augmentation or domain mix-up. For medical image segmentation, the UDA segmentation methods can be classified into image-level methods that use GANs and different types of data augmentation to transfer source domain data to the target domain, and feature-level methods, such as feature alignment methods that aim to learn domain-invariant features across domains. Examples of cardiac segmentation techniques can be referenced from documents such as: A novel unsupervised domain adaptation framework based on graph convolutional network and multi-level feature alignment for inter-subject ECG classification (Volume 221, 2023, 119711, ISSN 0957-4174); Automated cardiac segmentation of cross-modal medical images using unsupervised multi-domain adaptation and spatial neural attention structure (Medical Image Analysis Volume 72, August 2021 102135); Characterizing Spatio-temporal Patterns for Disease Discrimination in Cardiac Echo Videos (Medical Image Computing and Computer-Assisted Intervention-MICCAI 2007, 10th International Conference, Brisbane, Australia, Oct. 29-Nov. 2, 2007, Proceedings, Part I, DOI: 10.1007/978-3-540-75757-3_32); China patent no. CN 111476805 B; Coronary heart disease prediction method fusing domain-adaptive transfer learning with graph convolutional networks (Lin, H., Chen, K., Xue, Y. et al., Sci Rep 13, 14276 (2023)); Unsupervised Domain Adaptation for Cardiac Segmentation: Towards Structure Mutual Information Maximization (Proceedings of the IEEE/CVF conference on computer vision and pattern recognition. 2022:2588-2597); and GraphEcho: Graph-Driven Unsupervised Domain Adaptation for Echocardiogram Video Segmentation (Proceedings of the IEEE/CVF International Conference on Computer Vision. 2023:11878-11887). While existing methods tend to overlook the temporal consistency characteristics in heartbeat cycles and the local relationships between different chambers across domains, the method proposed herein effectively learns both inter-class differences and intra-class coherence while preserving temporal consistency. This advantageously leads to superior UDA segmentation results, and can accurately segment the cardiac structure of a heart, which not only allows for the diagnosis of multiple cardiac diseases such as pulmonary arterial hypertension (PHA) and atrial septal defect (ASD).

Graph neural networks (GNNs) have the ability to construct graphical representations to describe irregular objects of data. Also, graphs can iteratively aggregate the knowledge based on the broadcasting of their neighbouring nodes in the graph, which is more flexible for constructing the relationship among different components. The learned graph representations can be used in various downstream tasks, such as classification, object detection, vision-language, etc. Specifically, ViG models an image as a graph and uses GNN to extract high-level features for image classification. In an example, graphical representation instead of the feature space may be applied to explore multiple long-range contextual patterns from the different scales for more accurate object detection. GOT leverages the graphs to conduct the vision and language alignment for image-text retrieval. There also exist some works that use the graph to conduct cross-domain alignment for object detection and classification. However, these methods only capture the global graph information for images, which is insufficient for video segmentation tasks. In the present disclosure, the proposed method learns both local class-wise and temporal-wise graph representations, which can advantageously reduce the domain gap in a fine-grained approach and enhance temporal consistency, leading to an enhanced result.

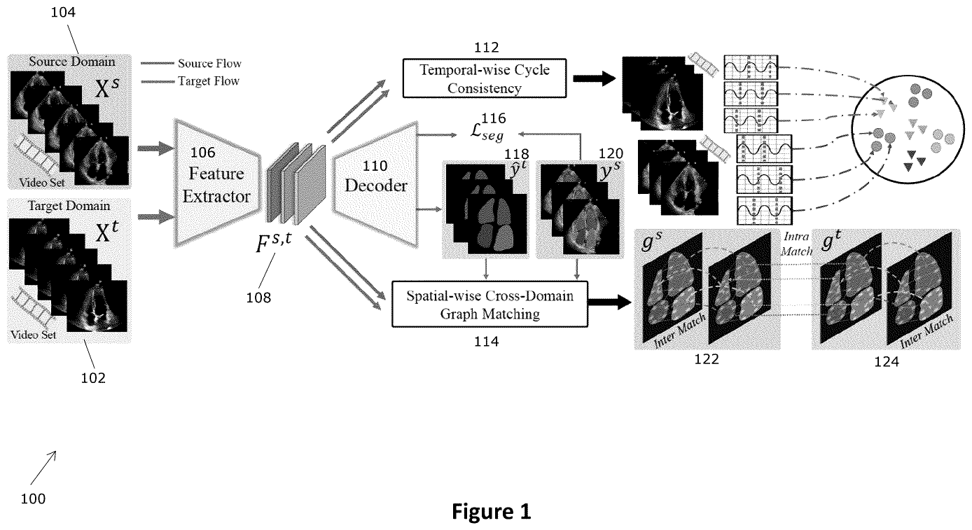

FIG. 1 shows an exemplary illustration 100 of a method for determining a shape of an object in an image according to certain embodiments of the present disclosure. The method may consist of three main components. First, a basic segmentation network comprising of a feature extractor 106 and a decoder 110 may be used to extract one or more features 108 and obtain prediction masks for both target and source domain data e.g., a first plurality of images 102 and a second plurality of images 104 respectively. Then, a Spatial-wise Cross-domain Graph Matching (SCGM) module 114 and a Temporal-wise Cycle Consistency (TCC) module 112 may be utilized to reduce the domain gap both spatially and temporally, for example, for echocardiogram videos.

In the UDA segmentation of illustration 100, the source (e.g., second plurality of images) and target domain data (e.g., first plurality of images) may be denoted as {X^{s}, Y^{s}} and X^{t}, respectively, where X^{s} is the video set in the source domain, and Y^{s} is its corresponding label set. Note that the videos set in the target domain X^{t} are without the label. For clarity, an image or video frame with the label {x^{s}, y^{s}} (e.g., see y^{s} 120) from an example {X^{s}, Y^{s}} of the source domain data may be sampled, where X^{s}∈X^{s} is a video from X^{s} and Y^{s}∈Y^{s} is its corresponding label. Similarly, an image or a video frame may also be sampled from the target domain, e.g., x^{t}.

The basic segmentation network of illustration 100 may consist of the feature extractor 106 and the decoder 110. The x^{s} (e.g., second plurality of images) or x^{t} (e.g., first plurality of images) may be input to the feature extractor 106 to obtain a plurality of features 108 e.g., f^{s} (e.g., a second plurality of features) or f^{t} (e.g., a first plurality of features) respectively, followed by the decoder 110 that maps the features f^{s} or f^{t} to a corresponding prediction mask, e.g., ŷ^{s} (see ŷ^{s} 118) or ŷ^{t}. Then, a segmentation loss 116 (e.g., L_{seg}) may be determined and utilized to supervise the model on a pixel classification task with the annotated source domain data as follows:

L_{seg}=L_{bce}(ŷ^{s},y^{s})+L_{dice}(ŷ^{s},y⁵), (1)

where L_{bce} and L_{dice} are the binary cross-entropy loss and dice loss respectively. Binary Cross-Entropy (BCE) Loss refers to a loss function used in machine learning, particularly in binary classification problems where the goal is to predict whether an input belongs to one of two classes (e.g., “yes” or “no”, “true” or “false”, “spam” or “not spam”). Further, a Dice loss or Dice score, also known as the Sørensen-Dice coefficient, is a metric used to evaluate a similarity or overlap between two sets of data. It is commonly used in the field of image segmentation, where it is used to measure the similarity between a predicted segmentation and the ground truth segmentation.

Thereafter, a spatial-wise cross-domain graph matching (SCGM) module 114 may be utilized to align both class-wise representations and their relations across the source and target domains. To this end, a graph may be used to model each echocardiogram frame, where a plurality of nodes in each graph represent the different chambers (e.g., LV, RV, LA and RA of a heart in the echocardiogram) and a plurality of edges in each graph illustrate the relations between them. Compared with the convolution neural network, the graph can better construct the relations among different classes explicitly. The features of source and target domains e.g., f^{s} and f^{t} may be converted to the corresponding graph representation, which is defined as g^{s} 122 and g^{t} 124 respectively. After that, a graph matching method may be utilized to align the generated graph to reduce the domain gap.

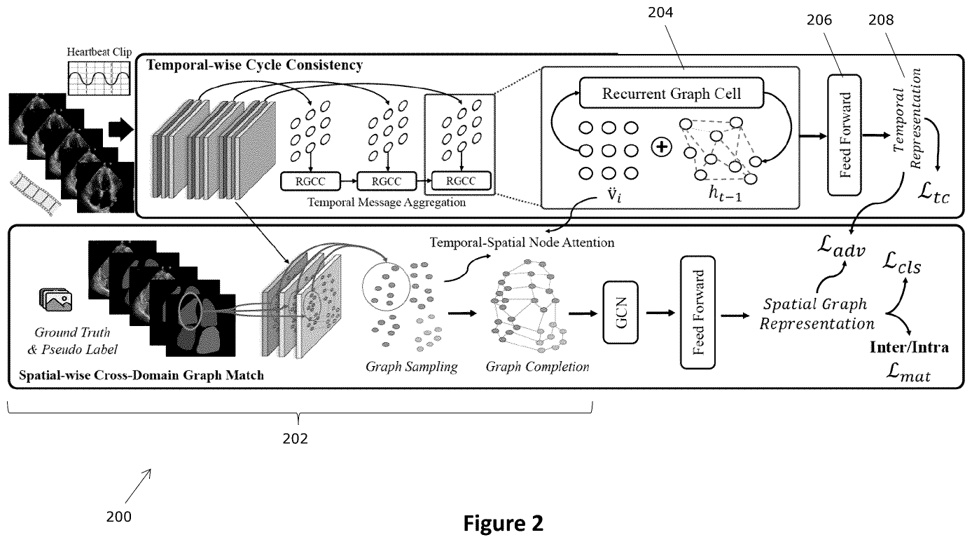

The graph construction aims to convert visual features to graphs. Since the construction process of the source domain and the target domain is the same, conversion for the source domain is explained herein for illustration. Formally, given the feature f^{s} and its corresponding pseudo labels ŷ^{s} for a video frame or an image, graph sampling may be conducted to sample a plurality of graph nodes from f^{s} based on ŷ^{s}, as shown in graph sampling 202 in illustration 200 of FIG. 2. Specifically, a plurality of pseudo labels ŷ^{s} may be utilized to segment f^{s} into different chamber regions, e.g., {fᵢ^{s}}. Then, in each chamber region, m feature vectors may be uniformly sampled e.g., fed into a projection layer to obtain a node embedding v^{s}. Based on v^{s}, edge connections e^{s} may be defined, which is a learned matrix. Finally, the constructed semantic graph for the source domain (e.g., generating, for each of a second plurality of images, a second graph based on a second plurality of features extracted from each of the second plurality of images and based on a second plurality of pseudo labels associated with the second plurality of images) can be defined as g^{s}={v^{s}, e^{s}} (e.g., see g^{s} 122). In this same way, a semantic graph for the target domain, e.g., g^{t}={v^{t}, e^{t}} (e.g., see g^{t} 124) may also be obtained (e.g., generating, for each of a first plurality of images, a first graph based on a first plurality of features extracted from each of the first plurality of images and based on a first plurality of pseudo labels associated with the first plurality of images). We leverage graph matching to perform the alignment of the source and target domain graphs g^{s} 122 and g^{t} 124, thus reducing the domain gap. Since graph matching is an optimization problem for g^{s} 122 and g^{t} 124, the relations between the two graphs may be utilized for an optimal solution. Hence, a self-attention technique (e.g., training a model to focus on the most relevant parts of an input sequence when generating an output.) to capture the intra- and inter-domain relations between the source and target graph nodes, e.g., v^{s} and v^{t} may be implemented, which can be formulated as v̅^{s}, v̅^{t}=Attention (concat (v^{t}, v^{s})), where concat indicates a concatenation (e.g., combining two or more features into one feature). To ensure the generated graph nodes are classified into the correct classes, a classification loss L_{cls} may be determined based on a comparison between the first and the second graphs (e.g., a comparison between a first plurality of nodes associated with the first graph and a second plurality of nodes associated with the second graph) as follows:

L_{cls}=−αy log(h(v̅^{s}))−βŷ log(h(v̅^{t})), (2)

where h is the classifier head followed by a softmax, and α, β are the weights for the source and target domains respectively. A softmax function takes a vector of real-valued inputs (often the outputs of a previous layer) and converts them into a vector of values between 0 and 1 that sum up to 1. Softmax is a function used in the final layer of a neural network for multi-class classification problems.

Further, graph matching may be implemented by maximising the similarity between graphs (including nodes and edges in the graphs) belonging to a same class but from two different domains. Specifically, an adjacency matrix A may be obtained from g^{s} 122 and g^{t} 124 to represent the relations among the graph nodes (e.g., performing an alignment of the first and second graphs based on an adjacency matrix). Then, the maximizing process may be transferred into optimizing a transport distance of adjacency matrix A. Transport distance, also known as the Wasserstein distance or the Earth Mover's distance, is a metric used to measure the similarity or dissimilarity between two probability distributions. To this end, a Sinkhorn algorithm or other similar algorithm may be utilized to obtain the transport cost matrix of the plurality of graphs among the chambers (e.g., LV, RV, LA and RA of a heart in the echocardiogram), defined as \vec{A}=Sinkhorn (A) (e.g., determining a transport cost matrix based on the aligned first and second graphs). Then, an optimization target can be formulated as follows:

$$\text{?} = {\sum }_{p , q} 𝕀 ( {y}_{p}^{s} = {\hat{y}}_{q}^{t} ) \cdot min ( \vec{A} ( p , q ) ) + 𝕀 ( {y}_{p}^{s} \neq {\hat{y}}_{q}^{t} ) \cdot max ( \vec{A} ( p , q ) ) , \qquad ( 3 )$$

where \vec{A}(p, q) is the p-th row and q-th column element on A, II(⋅) is the indicator function, and Lₘₐₜ is the graph matching loss (e.g., determining a graph matching loss based on the transport cost matrix). Equation (3) aims to minimize the distance between samples of the same class across different domains while increasing the distance between samples of different classes across domains, thus eliminating the influence of domain shift. Finally, L_{SCGM}=L_{cls}+Lₘₐₜ is the overall loss of module SCGM module 114.

Furthermore, a Temporal Cycle Consistency (TCC) module 112 may be utilized to enhance the temporal graphic representation learning across the plurality of images or frames, by leveraging the temporal morphology of echocardiograms, e.g., the discriminative heart cycle pattern across different patients. The proposed TCC may consist of three parts: a temporal graph node construction to generate a sequence of temporal graph nodes for each video; a recursive graph convolutional cell to learn the global graph representations for each video; a temporal consistency loss to enhance the intra-video similarity and reduce the inter-video similarity. The TCC may be applied to both source and target domains. In the following, the TCC is explained based on the source domain for clarity.

Given a video X⁸, a plurality of features (e.g., a second plurality of features) for the plurality of images or frames (e.g., a second plurality of images) may be defined as

$${\{ \text{?} \}}_{i = 1}^{N} = 1 ,$$

where fᵢ is the feature of the i-th image or frame and Nis the number of images or frames in X⁸. Considering the computation cost, an average pooling layer or other similar technique may be implemented to compress the size of each feature

$${\{ \text{?} \}}_{i = 1}^{N} = 1.$$

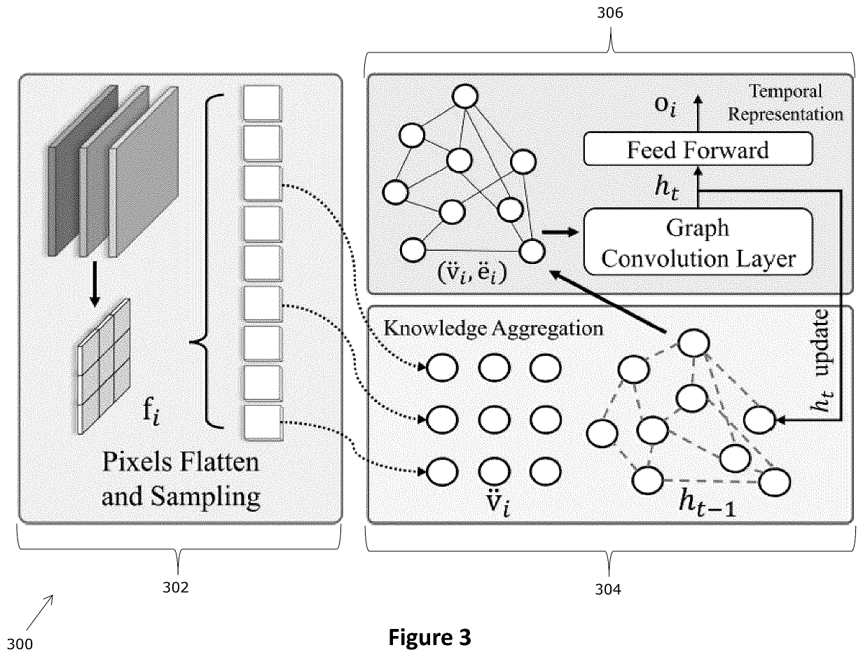

Referring to illustration 300 of FIG. 3, each compressed feature fᵢ^{s} may be flattened (e.g., as shown in 302 of illustration 300) and its plurality of pixels may be treated as a plurality of graphical nodes, e.g.

$${\ddot{v}}_{i}^{s} .$$

Thus, a plurality of temporal graph nodes for the video X⁸ may be defined as

$${\{ {\ddot{v}}_{i}^{s} \}}_{i = 1}^{N} .$$

Further, a recursive graph convolutional cell 204 (see illustration 200 of FIG. 2) may be utilized to aggregate the semantics of the temporal graph nodes

$${\{ {\ddot{v}}_{i}^{s} \}}_{i = 1}^{N}$$

(e.g., see 304 of illustration 300) for obtaining the global temporal representation of each video (e.g., see 306 of illustration 300). For the p-th node

$${\ddot{v}}_{i}^{s} ( p ) at {\ddot{v}}_{i}^{s} ,$$

we find its K nearest neighbors N(p) on a hidden state hₜ, where N(p)∈hₜ (e.g., determining, for each of the plurality of nodes, one or more other nodes based on historical data indicating a previous position and a time associated with the previous position of each of the second plurality of nodes). Then an edge

$${\ddot{e}}_{i}^{s}$$

(q, p) may be added directed from hₜ (q) to

$${\ddot{v}}_{i}^{s}$$

(p) for all hₜ(q)∈N(p). After obtaining the edge

$${\ddot{e}}_{i}^{s}$$

for

$${\ddot{v}}_{i}^{s}$$

(e.g., determining a plurality of edges for connecting the one or more other nodes with each of the plurality of nodes), the message broadcast from the i-th graph to the i+1-th graph can be defined as follows:

$${h}_{t + 1} = σ {w}_{gcn} ( {\ddot{v}}_{i}^{s} , {\ddot{e}}_{i}^{s} ) + {b}_{gcn} , \qquad ( 4 )$$

where the σ indicates the activation function, w_{gcn} and b_{gcn} are the graph convolution weight and bias, respectively. This message broadcast for

$${\{ {\ddot{v}}_{i}^{s} , {\ddot{e}}_{i}^{s} \}}_{i = 1}^{N}$$

may be conducted to obtain a final hidden state h_{N}. The final hidden state refers to a hidden state of the network after it has processed the entire input sequence e.g., the first and second plurality of images. The global representation for video X^{s} is the o^{s}, obtained by o^{s}=FFN(h_{N}), where FFN is a feed forward network 206. Hence, the whole process of recursive graph convolutional cell can be formulated as o^{s}=RGCC(X^{s}). Similarly, a temporal representation 208 for the target domain video X^{t} (e.g., the first plurality of images) may be obtained by o^{t}=RGCC(X^{t}). A temporal representation refers to one or more features learned by the network about cardiac motion patterns in the first plurality of images (e.g., echocardiogram videos).

For better representation learning, temporal consistency loss may be leveraged to make features from a same video similar and features from different videos dissimilar. In the present disclosure, contrastive learning is used, which is a mainstream method to pull close the positive pairs and push away negative ones, to achieve this goal. However, other similar methods may also be utilized. For example, two consequent clips

$${X}_{k}^{s}$$

and

$${X}_{+}^{s}$$

may be randomly sampled from a video X^{s} as positive pairs. Then, these positive clips are input to the recursive graph convolutional cell to obtain the global representations, e.g.,

$${o}_{k}^{s} = RGCC ( {X}_{k}^{s} ) and {o}_{+}^{s} = RGCC ( {X}_{+}^{s} ) .$$

For negative pairs, a memory bank B consisting of representations of clips sampled from different videos may be maintained. Then, the temporal consistency loss for the source domain (e.g., obtaining temporal consistency loss for the source domain based on global representation(s) for the source domain) is defined as follows:

$$\text{?} = - {\sum }_{\{ {o}_{k}^{s} , {o}_{+}^{s} \} ∈ {𝒫}^{s}} log \frac{exp ( {o}_{k}^{s} \cdot {o}_{+}^{s} )}{{\sum }_{{o}_{-}^{s} ∈ ℬ} exp ( {o}_{k}^{s} \cdot {o}_{-}^{s} )} , \qquad ( 5 )$$

where P^{s} is the set of positive pairs. A dot product or other similar method may be used here to measure the similarity, and InfoNCE or other similar method may be used as the specific contrastive learning objective. Similarly, the temporal consistency loss for the target domain (e.g., obtaining temporal consistency loss for the target domain based on global representation(s) for the target domain) may be defined as L_{ttc}, and the total temporal consistency loss (e.g., obtaining total temporal consistency loss based on a first global representation for the target domain and the second global representation for the source domain) is L_{tc}=L_{stc}+L_{ttc}.

Since L_{tc} is applied to two domains independently, a gap between source and target domains still exists for the learned global representation, e.g., o^{s} or o^{t}. Hence, adversarial methods may be utilized to eliminate the gap between o^{s} and o^{t}, which can be formulated as Lady. The overall loss of temporal consistency is L_{TCC}=L_{tc}+L_{adv}, where L_{adv} is the global domain-adversarial loss in our TCC module. To summarize, the final loss of GraphEcho is L_{All}=L_{SCGM}+L_{TCC}+L_{seg}, and the network is trained in end-to-end.

The proposed method of illustration 100 was evaluated on two datasets, namely CAMUS and Echonet Dynamic. CAMUS consists of 500 echocardiogram videos with pixel-level annotations for the left ventricle, myocardium, and left atrium. To save the annotation cost, only 2 frames (end diastole and end systole) are labelled in each video. The dataset was randomly split into 8:1:1 for training, validation, and testing. Echonet Dynamic is the largest echocardiogram video dataset, including 10,030 videos with human expert annotations. Similarly, these videos were split into 8:1:1 for training, validation, and testing, respectively.

All methods used for training on the two datasets were built on a “DeepLabv3” backbone for a fair comparison. The model was trained using the stochastic gradient descent (SGD) optimizer with a weight decay of 0.0001 and a momentum of 0.9. The model was trained for a total of 400 epochs with an initial learning rate of 0.02, and the learning rate was decreased by a factor of 0.1 every 100 epochs. The batch size was set to 4. For spatial data augmentation, each frame was resized to 384×384 and then randomly cropped to 256×256. The frames were also randomly flipped vertically and horizontally. As for temporal data augmentation, 40 frames were randomly selected from an echocardiogram video and sampled 10 frames as input equidistantly. For the CAMUS and Echonet dynamic datasets, the same training and data augmentation approach were followed.

For validation and testing, the model with the highest performance on the validation set was chosen and its results on the testing set were reported. During the inference stage, only center cropping was used as the preprocessing.

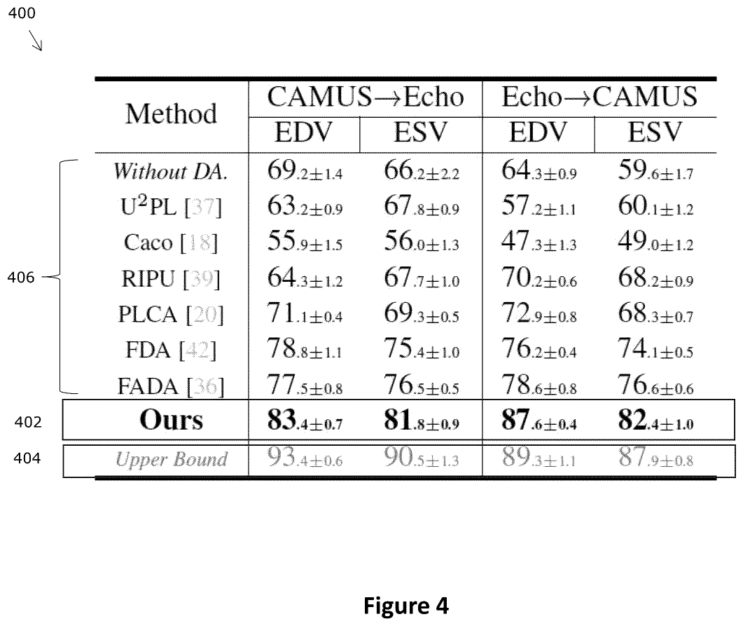

Table 400 of FIG. 4 shows the results of the UDA methods on the three datasets (CardiacUDA, CAMUS, and Echonet) under six settings. As only LV segmentation labels were provided in these three datasets, only the results on a Dice score of LV segmentation are provided in the table. “EDV” and “ESV” refers to the Dice score of LV segmentation results at end-systole and end-diastole frames, respectively. All results are reported in Dice score (%). In Table 400, ‘a→b’ indicates that a is the source domain and b is the target domain. As can be seen in Table 400, the proposed method can achieve excellent performance under six settings. Notably, as shown in Echo→CAMUS, the proposed method (see row 402 of Table 400) can achieve 87.6% and 82.4% on Dice (e.g., a metric used to evaluate a similarity or overlap between two sets of segmented regions) for EDV and ESV, respectively, which are very close to the upper bound (see row 404 of Table 400) of this setting. The proposed method was also compared with state-of-the-art methods on different settings as shown in the remaining rows 406 of Table 400, which shows the proposed method outperforming all other methods with significant improvements.

Table 500 shows the effectiveness of the proposed SCGM and TCC. “Base” indicates the basic segmentation network. The results show that adopting SCGM can largely improve the base model from 48.5% to 74.3% under setting G-R. However, only applying TCC shows limited improvements over the base model. This is mainly because the TCC is designed to jointly train unlabelled data and construct better graphical representation in a temporal manner, which does not include any operation that focuses on narrowing the domain discrepancy, leading to limited adaptation results. Thus, a combination of both SCGM and TCC in the proposed method can achieve the best performance.

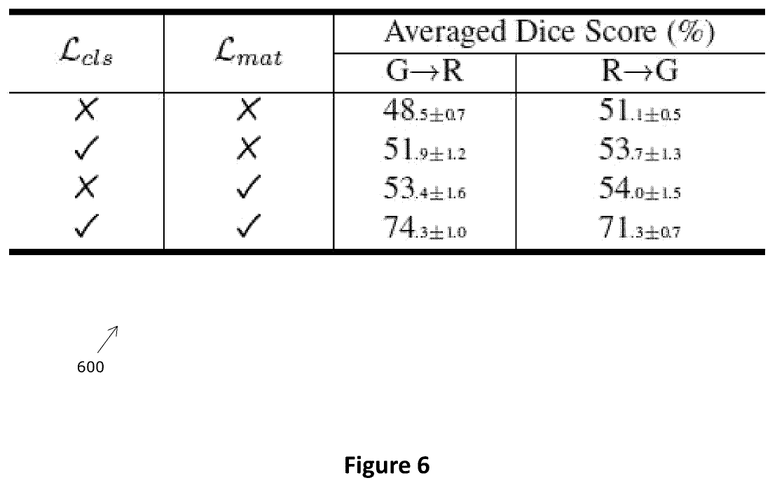

Since there are two loss functions, e.g., L_{χλσ} (Eq. 2) and L_{ματ} (Eq. 3) in SCGM, their effects are ablated in Table 600 of FIG. 6. The results illustrate that using L_{χλσ} and L_{ματ} alone can only achieve limited improvements. This is because only using L_{χλσ} cannot align the representations from different domains well, while only using L_{ματ} may perform erroneous alignment, e.g., align the features of LV to those of RV. By combining two losses, the correct class-wise alignment can be conducted and significant improvement can advantageously be achieved.

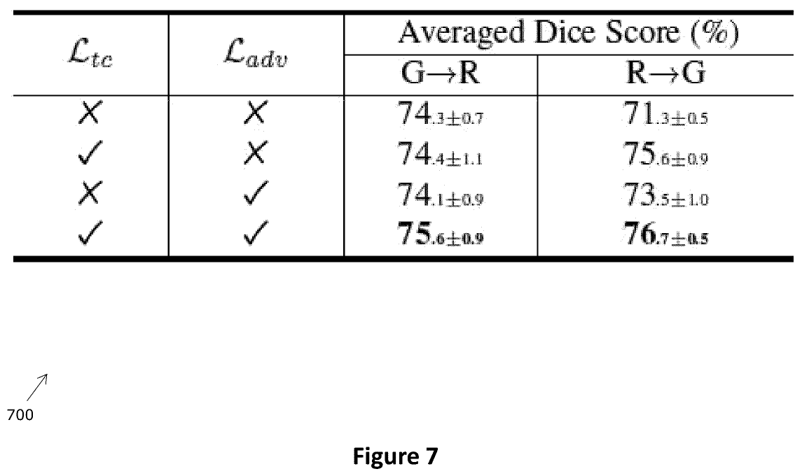

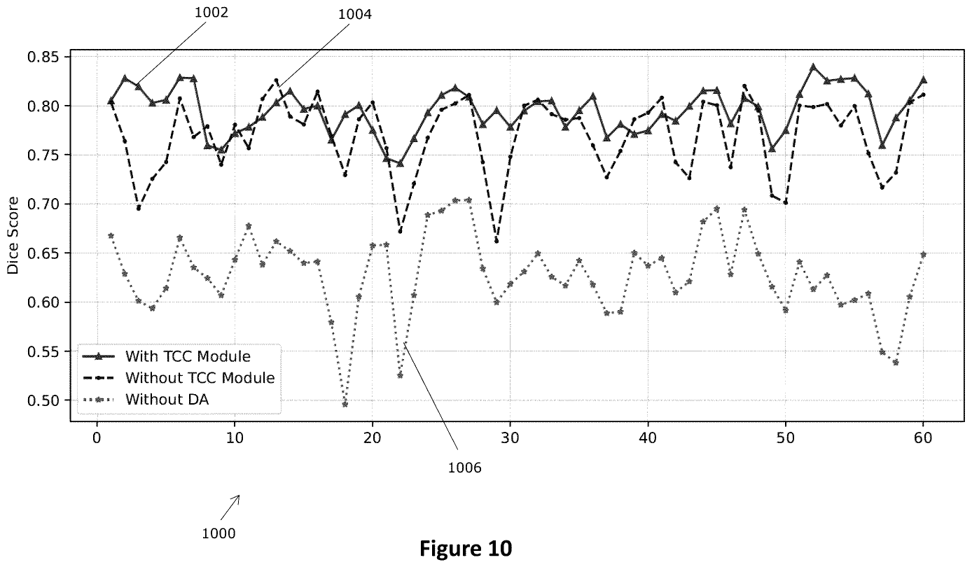

The effects of two loss functions (L_{tc} (Eq. 5) and L_{adv}) in TCC of the proposed method are shown in Table 700 of FIG. 7. In this ablation study, SCGM is used as the baseline model, which has been ablated. We can see that both L_{tc} and L_{adv} can benefit the model, and using two losses can achieve the best performance. For the visualisation of the effectiveness of the TCC module, Illustration 1000 of FIG. 10 illustrates that the segmentation result generated by a framework with the TCC module is able to present more consistent performance (e.g., marked by the line 1002) in a video. The results without the TCC module (e.g., marked by the line 1004) or disabling the domain adaptation (e.g., marked by the line 1006) perform worse in terms of segmentation consistency.

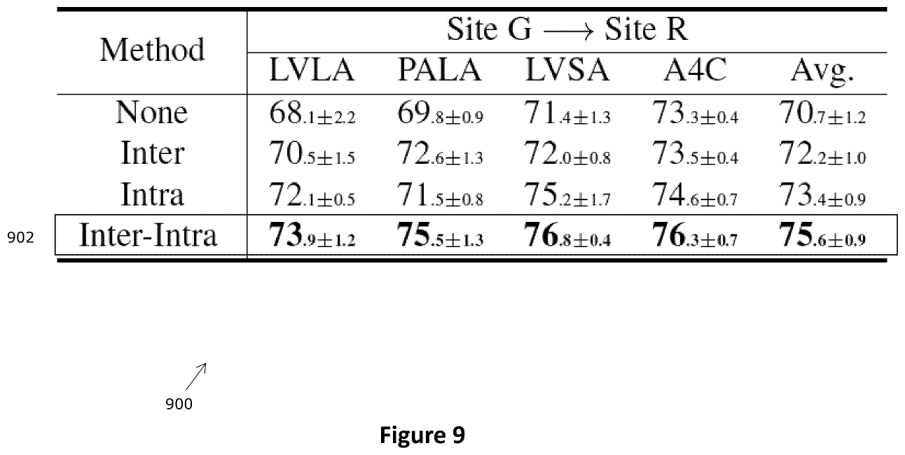

Further, in Table 900 of FIG. 9, different node attention methods are compared. “None” denotes that no attention module is applied in the framework, while the “Inter”, “Intra”, and “Inter-Intra” refers to cross-domain, internal domain, and dual (cross+internal) attention, respectively. The results show that inter-intra attention (e.g., as shown in row 902) achieves the best performance in our datasets, which indicates the relations between different domains are important to improve the performance.

Furthermore, illustration 1000 of FIG. 10 also shows the Dice score for each frame in a video (e.g., a plurality of images) example. Compared to results without using TCC, the proposed method (e.g., marked by the line 1002) produces better results with enhanced temporal consistency, showing the effectiveness of the TCC module in learning temporal information.

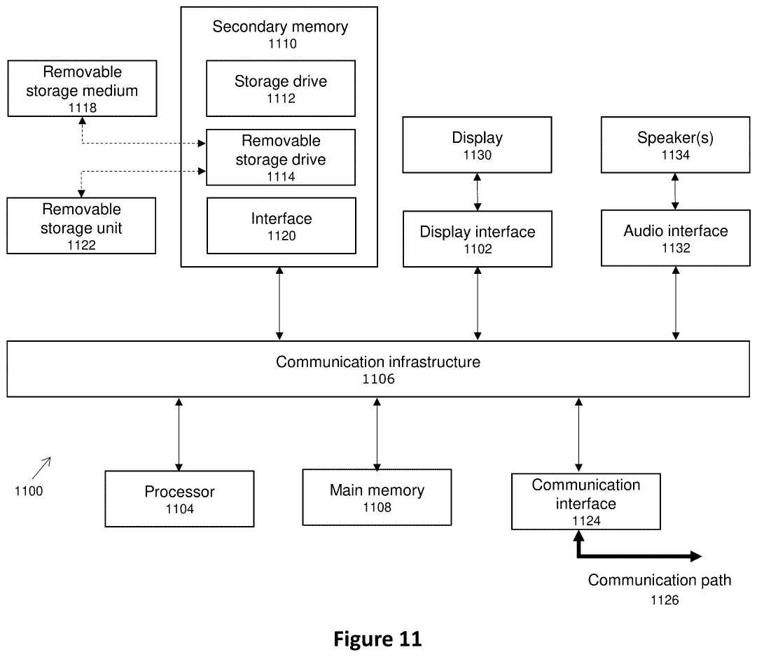

FIG. 11 shows a schematic diagram of an exemplary computing device suitable for use in determining a shape of an object in an image.

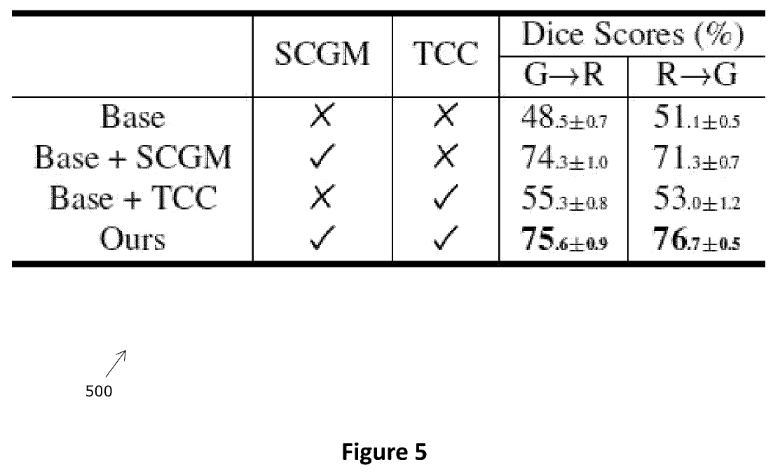

FIG. 11 depicts an exemplary computing device 1100, hereinafter interchangeably referred to as a computer system 1100, where one or more such computing devices 1100 may be used as a system for determining a shape of an object in an image and execute the processes and calculations as depicted in at least FIGS. 1 to 10. The following description of the computing device 1100 is provided by way of example only and is not intended to be limiting.

As shown in FIG. 11, the example computing device 1100 includes a processor 1104 for executing software routines. Although a single processor is shown for the sake of clarity, the computing device 1100 may also include a multi-processor system. The processor 1104 is connected to a communication infrastructure 1106 for communication with other components of the computing device 1100. The communication infrastructure 1106 may include, for example, a communications bus, cross-bar, or network.

The computing device 1100 further includes a main memory 1108, such as a random access memory (RAM), and a secondary memory 1110. The secondary memory 1110 may include, for example, a storage drive 1112, which may be a hard disk drive, a solid state drive or a hybrid drive and/or a removable storage drive 1114, which may include a magnetic tape drive, an optical disk drive, a solid state storage drive (such as a USB flash drive, a flash memory device, a solid state drive or a memory card), or the like. The removable storage drive 1114 reads from and/or writes to a removable storage medium 1118 in a well-known manner. The removable storage medium 1118 may include magnetic tape, optical disk, non-volatile memory storage medium, or the like, which is read by and written to by removable storage drive 1114. As will be appreciated by persons skilled in the relevant art(s), the removable storage medium 1118 includes a computer readable storage medium having stored therein computer executable program code instructions and/or data.

In an alternative implementation, the secondary memory 1110 may additionally or alternatively include other similar means for allowing computer programs or other instructions to be loaded into the computing device 1100. Such means can include, for example, a removable storage unit 1122 and an interface 1120. Examples of a removable storage unit 1122 and interface 1120 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1122 and interfaces 1120 which allow software and data to be transferred from the removable storage unit 1122 to the computer system 1100.

The computing device 1100 also includes at least one communication interface 1124. The communication interface 1124 allows software and data to be transferred between computing device 1100 and external devices via a communication path 1126. In various embodiments of the disclosures, the communication interface 1124 permits data to be transferred between the computing device 1100 and a data communication network, such as a public data or private data communication network. The communication interface 1124 may be used to exchange data between different computing devices 1100 which such computing devices 1100 form part an interconnected computer network. Examples of a communication interface 1124 can include a modem, a network interface (such as an Ethernet card), a communication port (such as a serial, parallel, printer, GPIB, IEEE 1394, RJ45, USB), an antenna with associated circuitry and the like. The communication interface 1124 may be wired or may be wireless. Software and data transferred via the communication interface 1124 are in the form of signals which can be electronic, electromagnetic, optical or other signals capable of being received by communication interface 1124. These signals are provided to the communication interface via the communication path 1126.

As shown in FIG. 11, the computing device 1100 further includes a display interface 1102 which performs operations for rendering images or videos to an associated display 1130 and an audio interface 1132 for performing operations for playing audio content via associated speaker(s) 1134.

As used herein, the term “computer program product” may refer, in part, to removable storage medium 1118, removable storage unit 1122, a hard disk installed in storage drive 1112, or a carrier wave carrying software over communication path 1126 (wireless link or cable) to communication interface 1124. Computer readable storage media refers to any non-transitory, non-volatile tangible storage medium that provides recorded instructions and/or data to the computing device 1100 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1100. Examples of transitory or non-tangible computer readable transmission media that may also participate in the provision of software, application programs, instructions and/or data to the computing device 1100 include radio or infra-red transmission channels as well as a network connection to another computer or networked device, and the Internet or Intranets including e-mail transmissions and information recorded on Websites and the like.

The computer programs (also called computer program code) are stored in main memory 1108 and/or secondary memory 1110. Computer programs can also be received via the communication interface 1124. Such computer programs, when executed, enable the computing device 1100 to perform one or more features of embodiments discussed herein. In various embodiments, the computer programs, when executed, enable the processor 1104 to perform features of the above-described embodiments. Accordingly, such computer programs represent controllers of the computer system 1100.

Software may be stored in a computer program product and loaded into the computing device 1100 using the removable storage drive 1114, the storage drive 1112, or the interface 1120. The computer program product may be a non-transitory computer readable medium. Alternatively, the computer program product may be downloaded to the computer system 1100 over the communications path 1126. The software, when executed by the processor 1104, causes the computing device 1100 to perform, as a system for determining a shape of an object in an image, the necessary operations to execute the processes, perform the calculations, and other similar computations as shown in FIGS. 1-10.

It is to be understood that the embodiment of FIG. 11 is presented merely by way of example to explain the operation and structure of a system for determining a shape of an object in an image. Therefore, in some embodiments one or more features of the computing device 1100 may be omitted. Also, in some embodiments, one or more features of the computing device 1100 may be combined together. Additionally, in some embodiments, one or more features of the computing device 1100 may be split into one or more component parts.

It will be appreciated by a person skilled in the art that numerous variations and/or modifications may be made to the present disclosure as shown in the specific embodiments without departing from the scope of the disclosure as broadly described. The present embodiments are, therefore, to be considered in all respects to be illustrative and not restrictive.

1. A method for determining a shape of an object in an image, the method comprising:
generating, for each of a first plurality of images, a first plurality of nodes based on a first plurality of features extracted from each of the first plurality of images, the first plurality of features associated with a shape of an object in the first plurality of images;
determining, for each of the first plurality of nodes, one or more other nodes based on historical data indicating a previous position and a time associated with the previous position of each of the first plurality of nodes; and
determining the shape of the object for each of the first plurality of images based on the one or more other nodes.

2. The method of claim 1, wherein determining the one or more other nodes further comprises determining a first plurality of edges for connecting the one or more other nodes with each of the plurality of nodes, and generating a first global representation of the first plurality of images based on a processing of the first plurality of edges and the first plurality of nodes.

3. The method of claim 2 further comprising:
generating, for each of a second plurality of images, a second plurality of nodes based on a second plurality of features extracted from each of the second plurality of images, the second plurality of features associated with a shape of an object in the second plurality of images;
determining, for each of the second plurality of nodes, one or more other nodes based on historical data indicating a previous position and a time associated with the previous position of each of the second plurality of nodes;
determining a second plurality of edges for connecting the one or more other nodes with each of the second plurality of nodes; and
generating a second global representation of the second plurality of images based on a processing of the second plurality of edges and the second plurality of nodes.

4. The method of claim 3 further comprising determining a total temporal consistency loss based on the first and second global representations.

5. The method of claim 4 further comprising:
generating, for each of the first plurality of images, a first graph based on the first plurality of features extracted from each of the first plurality of images and based on a first plurality of pseudo labels associated with the first plurality of images;
generating, for each of a second plurality of images, a second graph based on the second plurality of features extracted from each of the second plurality of images and based on a second plurality of pseudo labels associated with the second plurality of images;
performing an alignment of the first and second graphs based on an adjacency matrix; and
further determining the shape of the object based on the aligned first and second graphs.

6. The method of claim 5 further comprising determining a classification loss based on a comparison between the first and the second plurality of nodes.

7. The method of claim 5 further comprising:
determining a transport cost matrix based on the aligned first and second graphs; and
determining a graph matching loss based on the transport cost matrix.

8. The method of claim 1, wherein the object is one or more of a left ventricle (LV), a right ventricle (RV), a left atrium (LA), and a right atrium (RA) of a heart.

9. A system for determining a shape of an object in an image, the system comprising:
at least one processor; and
at least one memory including computer program code; the at least one memory and the computer program code configured to, with the at least one processor, cause the system at least to:
generate, for each of a first plurality of images, a first plurality of nodes based on a first plurality of features extracted from each of the first plurality of images, the first plurality of features associated with a shape of an object in the first plurality of images;
determine, for each of the first plurality of nodes, one or more other nodes based on historical data indicating a previous position and a time associated with the previous position of each of the first plurality of nodes; and
determine the shape of the object for each of the first plurality of images based on the one or more other nodes.

10. The system of claim 9, wherein determining the one or more other nodes further comprises determining a first plurality of edges for connecting the one or more other nodes with each of the plurality of nodes, and generating a first global representation of the first plurality of images based on a processing of the first plurality of edges and the first plurality of nodes.

11. The system of claim 10 further comprising:
generating, for each of a second plurality of images, a second plurality of nodes based on a second plurality of features extracted from each of the second plurality of images, the second plurality of features associated with a shape of an object in the second plurality of images;
determining, for each of the second plurality of nodes, one or more other nodes based on historical data indicating a previous position and a time associated with the previous position of each of the second plurality of nodes;
determining a second plurality of edges for connecting the one or more other nodes with each of the second plurality of nodes, and
generating a second global representation of the second plurality of images based on a processing of the second plurality of edges and the second plurality of nodes.

12. The system of claim 11 further comprising determining a total temporal consistency loss based on the first and second global representations.

13. The system of claim 12 further comprising:
generating, for each of the first plurality of images, a first graph based on the first plurality of features extracted from each of the first plurality of images and based on a first plurality of pseudo labels associated with the first plurality of images;
generating, for each of a second plurality of images, a second graph based on the second plurality of features extracted from each of the second plurality of images and based on a second plurality of pseudo labels associated with the second plurality of images;
performing an alignment of the first and second graphs based on an adjacency matrix; and
further determining the shape of the object based on the aligned first and second graphs.

14. The system of claim 13 further comprising determining a classification loss based on a comparison between the first and the second plurality of nodes.

15. The system of claim 13 further comprising:
determining a transport cost matrix based on the aligned first and second graphs; and
determining a graph matching loss based on the transport cost matrix.

16. The system of claim 9, wherein the object is one or more of a left ventricle (LV), a right ventricle (RV), a left atrium (LA), and a right atrium (RA) of a heart.
